(19) United States
(12) Patent Application Publication
(10) Pub. No.: US 2019/0305500 A1
(43) Pub. Date: Oct. 3, 2019

(54) COMPACT AND HIGH AVERAGE POWER COMPRESSOR

(71) Applicant: THALES, Courbevoie (FR)

(72) Inventors: Marie ANTIER, Guyancourt (FR); Alain PELLEGRINA, Guyancourt (FR); Sébastien LAUX, Guyancourt (FR); Mathilde CHARBONNEAU, Guyancourt (FR)

(21) Appl. No.: 16/316,009

(22) PCT Filed: Jul. 3, 2017
(86) PCT No.: PCT/EP2017/066430

§ 371 Date: Jan. 7, 2019

(30) Foreign Application Priority Data
Jul. 13, 2016 (FR) 1601095

(51) Int. Cl. H01S 3/00; H01S 3/23

(52) U.S. Cl. CPC H01S 3/0057; H01S 3/2316

(57) ABSTRACT

A folded compressor for a frequency shift system with a predetermined stretch ratio and which includes a compression network positioned to receive an input pulse and an output pulse of the compressor, mounted on a device for dynamic translation and rotation adjustment; a fold dihedral and at least one height adjustment dihedral, the compression network and the dihedrals being configured to form at least two stretched pulses on the compression network. The compression network is divided into two compression sub-networks with the same optical properties, mounted on the adjustment device: a first compression sub-network of determined length L for containing the stretched pulses, but not the input and output pulses, a second compression sub-network of length L2 for containing the input and output pulses, but not the stretched pulses, with L2<l1.

The field of the invention is that of lasers having an ultra-brief pulse duration, typically of less than 1 ps.

Such laser pulses are obtained by way of a pulse-compression laser amplification device, also called frequency-shift system 100 (or CPA, acronym for the expression “chirped pulse amplifier”), that may be seen in FIG. 1. A laser pulse 10 having low energy and a short duration provided by a generator 0 is:

temporally stretched by way of a stretcher 1 (the longest wavelengths arrive before the shortest wavelengths, but remain together spatially) into a pulse 11 having low peak energy and a long duration; stretch ratio is the name given to the ratio between the duration of the pulse after stretching and the pulse duration before stretching,
the stretched pulse 11 is then amplified by an amplifier 2 into a high-energy pulse 12 of long duration; this amplifier 2 is typically formed of a series of amplifiers in cascade,
the stretched and amplified pulse 12 is then compressed, by a compressor 3, into a pulse 13 having high peak energy and a short duration.

The pulse duration at the input and at the output of a CPA system is close to the Fourier limit (typically between a few hundred and a few tens of fs).

The compressor 3 makes it possible to compress pulses that may reach a pulse duration of a few ns at the input of the compressor to a few hundred fs, or even tens of fs, at the output of the compressor. The compressor is a critical component in a frequency-shift architecture, as its optical components (compression arrays, dihedra) have to withstand the entirety of the average power and of the peak power of the laser after compression. Compression array is the name given to a diffraction array used in a compressor. Moreover, in some lasers, the compression ratio, defined as the ratio between the pulse duration before compression and the pulse duration after compression, may be very high, ranging up to several tens of thousands (100 000 for example). In general, the compression ratio is equal to the stretch ratio. This compression ratio fixes the size of the compressor.

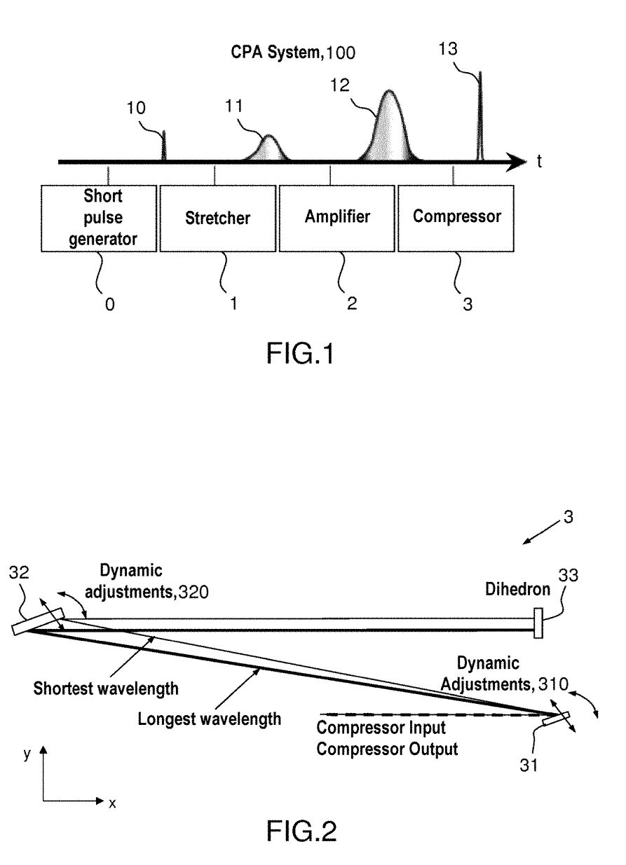

Among current compressor architectures used to compress a pulse 12 stretched with a high stretch ratio and then amplified, mention may be made of the following:
A “conventional” compressor architecture 3 or Treacy compressor, shown in FIG. 2, with 2 compression arrays 31, 32. In the case of a compression ratio of several tens of thousands, the distance between the two arrays 31, 32 is several meters. This non-compact architecture may make the compression of the pulse unstable over time. In addition, adjustment of this architecture is performed on both arrays 31, 32, each installed on its own dynamic translational and rotational adjustment device 310, 320 (symbolized by two arrows), thereby making this adjustment difficult to perform.

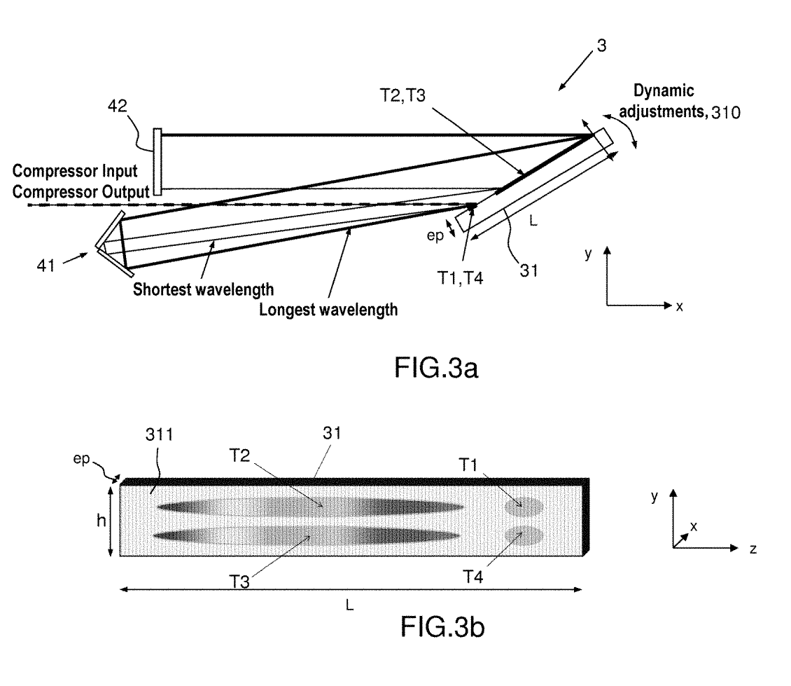

To reduce the size of the compressor 3 and improve its stability, it is possible to use a folded architecture, as shown in FIG. 3a. This has the advantage of approximately halving the distance between the optical elements, of facilitating adjustments with the use of a single compression array 31 installed on a single dynamic translational and rotational adjustment device 310 (symbolized by two arrows), and of focusing the dynamic optimization adjustments on the single compression array.

However, this architecture requires acquiring a large array 31, with a length typically greater than 500 mm. As these arrays are not normally offered by manufacturers, their cost is high and their supply time is significant, possibly being twice as long in comparison with those of what are called “standard” arrays (=having a length shorter than 500 mm).

In addition, given the length L of the array, its thickness ep is also significant, typically 10% of its length, so as to ensure good wavefront quality at the output of the compressor. This thickness limits the possibility of rear cooling of the arrays to manage heat, notably in the case of pulses having high average powers, such as greater than 300 W, at the input of the compressor, or having high peak powers, such as greater than 1 TW, at the output of the compressor.

As a result, there remains to this day a need for a compressor for a CPA system that simultaneously satisfies all of the above requirements, in terms of bulk, of supply time and cost, of ease of adjustment and of average and/or peak power.

The solution that is provided makes it possible to retain a folded architecture while at the same time adapting it to any high average powers, by dividing the single long compression array into two compression sub-arrays:
a large sub-array that sees the pulse with the stretched spectrum, which has no problem withstanding the flux in terms of peak power or of average power,
a smaller sub-array, of standard size, that sees the compressor input and output pulses, which therefore withstands the peak and average power.

More precisely, one subject of the invention is a folded compressor for a frequency-shift system having a predetermined stretch ratio and comprising:
a compression array positioned so as to receive a compressor input pulse and output pulse, installed on a dynamic translational and rotational adjustment device,
a folding dihedron and
at least one height-adjustment dihedron,
the compression array and the dihedra being configured to form at least two stretched pulses on the compression array.

It is characterized primarily in that the compression array is divided into two compression sub-arrays having the same optical properties, installed on said adjustment device:
a first compression sub-array of determined length L1 for completely containing the stretched pulses but not the input pulse and output pulse,
a second compression sub-array of length L2 for completely containing the input pulse and the output pulse but not the stretched pulses, where L2<L1.

The two compression sub-arrays are situated side by side on a single translational and rotational adjustment device. The marks of the two sub-arrays are aligned with one another (so as to be parallel with one another) once and for all before they are installed inside the compressor. Once they have been installed in the compressor, the two sub-arrays behave like a single array with a shared adjustment device, thereby facilitating adjustment and making it possible to retain the advantages of the dynamic adjustment of the folded architecture. By transferring the problems of withstanding the flux to a standard component (=the small sub-array), this makes it possible to reduce supply times and also costs in the event of breakage.

According to one feature of the invention, the first compression sub-array has a thickness ep1 and the second compression sub-array has a thickness ep2, where ep2<ep1.

As the compression sub-array withstanding the high average power is of shorter length, its thickness is all the smaller. This thinner thickness allows better cooling of this sub-array, thereby reducing its sensitivity to damage and the deformation of the wavefront of the laser pulse at the output of the compressor.

The input pulse typically has an average power greater than 300 W.

This technical solution also applies in the case of a folded architecture with a high peak power. The arguments in terms of speed of supply and of lower cost remain valid.

Another subject of the invention is a frequency-shift system comprising a stretcher, an amplifier and a compressor as described.

Other features and advantages of the invention will become apparent on reading the detailed description that follows, given by way of nonlimiting example and with reference to the appended drawings, in which:

FIG. 1, already described, schematically shows a frequency-shift amplification system according to the prior art, on which the effect of each element on the pulses (energy as a function of time) is indicated,

FIG. 2, already described, schematically shows a first example of a compressor having two compression arrays according to the prior art, seen in cross section,

FIG. 3a, already described, schematically shows a second example of a folded compressor, comprising a single compression array according to the prior art, seen in cross section, and FIG. 3b shows the spatial distribution of the pulse on the single array,

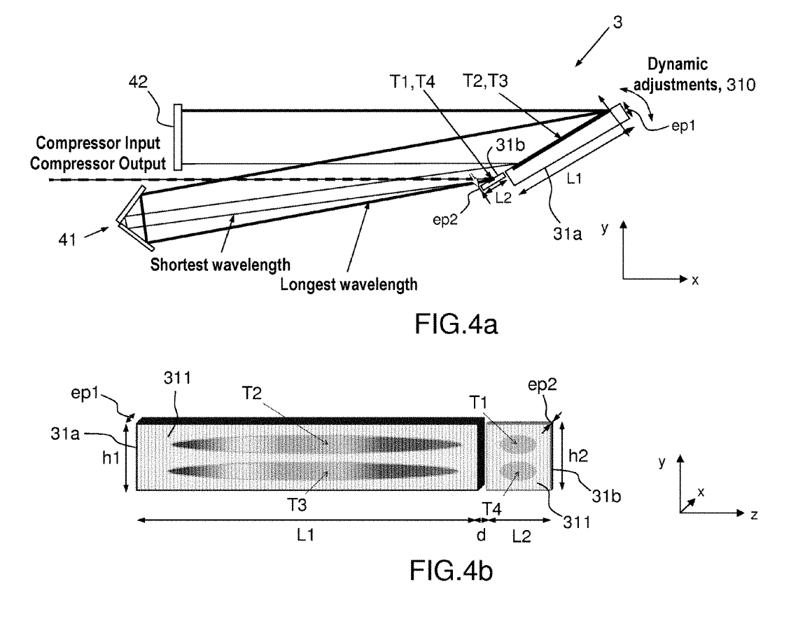

FIG. 4a schematically shows an example of a folded compressor, comprising two compression sub-arrays according to the invention, seen in cross section, and FIG. 4b shows the spatial distribution of the pulse on these sub-arrays.

From one figure to another, the same elements bear the same references.

In the rest of the description, the expressions “high”, “low” and “side” are used with reference to the orientation of the described figures. Insofar as the compressor may be positioned in other orientations, the directional terminology is indicated by way of illustration and is not limiting.

FIG. 3b shows the spatial distribution of a pulse on the single array 31 of a folded compressor 3, during travel thereof through the compressor. The pulse 12 forms, on the compression array 31 of length L, of height h and of thickness ep:
a spot T1 at the input, temporally stretched as a function of the wavelength, which
after being returned by the array 31 to the folding dihedron 41 that returns it to the array 31, forms a spot T2 that is spectrally stretched in the spatial domain, which
after being returned by the array 31 to the height-adjustment dihedron 42 that returns it to the array 31, forms a spot T3 that is spectrally stretched in the spatial domain and situated beneath T2 along the height h, which
after being returned by the array 31 to the folding dihedron 41 that returns it to the array 31, forms a spot T4 situated beneath T1 along the height h and representing the temporally compressed output pulse 13.

Given that the input pulse T1 and output pulse T4 are situated beside (along the length L) the pulses T2, T3 that are spectrally stretched in the spatial domain by the array 31, as may be seen in FIG. 3b, the length L of the single array 31 is far greater than the length of each array 31, 32 of a conventional architecture; the length L is at least equal to the sum of the lengths of the arrays 31 and 32.

According to the invention, the architecture of a folded compressor is modified so as to adapt more particularly to the case of a system having a high compression (or stretch) ratio in order to reduce the risks to this architecture in the case of pulses having notably high average power; of course, however, it is also able to be used in the case of pulses having low average power.

As the compressor input pulse T1 and output pulse T4 are each not very spatially stretched on the array 31, the average power density and peak power density on this area of the array are very high; the temporally compressed output pulse T4 is of course much more powerful than the temporally stretched input pulse T1. Therefore, the limits of the component in terms of withstanding the flux are focused on this area receiving T1 and T4, in fact above all T4. However, in the event of damage, the whole array will have to be replaced.

One example of a compressor according to the invention is described with reference to FIGS. 4a and 4b: the large single array 31 of FIG. 3a is separated into two compression sub-arrays 31a and 31b that are positioned side by side on the same dynamic translational and rotational adjustment device 310 (symbolized by two arrows). From the point of view of the translational and rotational adjustment, this pair of sub-arrays then behaves like a single array in the compressor, with the corresponding advantages (ease of adjustment, stability, etc.). These two sub-arrays of course have the same optical properties (paths of the marks 311 (only a few marks are shown in FIGS. 3b and 4b so as not to overcrowd them), wavelengths, full width at half maximum in terms of wavelength, etc.). FIG. 4b shows the view of the position of the pulses on the two sub-arrays:

A first compression sub-array 31a completely comprising the spectrally stretched pulses T2 and T3 but not T1 or T4, and which therefore has a long length L1 even if L1<L, thereby leading to a high cost and a long supply time. It has a height h1 that is a priori identical to h, and a thickness ep1 that is a priori smaller than ep, since L1<L. However, the average power density on this long sub-array 31a is low, limiting the risks of damage to the sub-array and of deformation of the wavefront.

A second compression sub-array 31b that is back to back with the (complete) compressor input pulse T1 and output pulse T4 but not T2 or T3, and which may therefore be of shorter length L2 (L2<L1) on account of the spatial dimension of these pulses. It is typically the case that (L1/L2)≥ compression ratio. It has a height h2 that may be shorter than h1, and a thickness ep2. This sub-array 31b therefore withstands a much higher average power density and therefore focuses all of the damage risks. As its length L2 is standard, its supply time is short and its cost is low, thereby reducing the drawbacks linked to any damage.

These two sub-arrays are separated by a distance d low enough so as not to increase the bulk of the compressor. A distance of between 0.3 and 3 mm is reasonable.

In addition, since L2<L1, it is advantageously possible to have ep2<ep1, thereby allowing better thermal cooling. This better thermal management limits the risk of damage and prevents excessively great deformation of the wavefront.

Such a compressor makes it possible to retain the advantages of the folded architecture in terms of compactness, of adjustment—the two sub-arrays 31a and 31b are situated on a shared translational and rotational adjustment device 310—and of stability.

These advantages are kept in the case of an even more folded architecture with the addition of additional dihedra. The addition of each new height dihedron doubles the number of pulses on the array 31a. All of the stretched pulses are superimposed along h1, as may be seen in FIG. 4b. If this number of stretched pulses means that h1>L1, then the thickness ep1 is of course determined as a function of h1, the largest dimension.

1. A folded compressor for a frequency-shift system having a predetermined stretch ratio and comprising:
a compression array positioned so as to receive a compressor input pulse and output pulse, installed on a dynamic translational and rotational adjustment device,
a folding dihedron and
at least one height-adjustment dihedron,
the compression array and the dihedra being configured to form at least two stretched pulses on the compression array,
wherein the compression array is divided into two compression sub-arrays having the same optical properties, installed on said adjustment device:
a first compression sub-array of thickness ep1 and of determined length L1 for completely containing the stretched pulses but not the input pulse and the output pulse,
a second compression sub-array of thickness ep2, where ep2<ep1, and of length L2 for completely containing the input pulse and the output pulse but not the stretched pulses, where L2<L1.

2. (canceled)

3. The compressor as claimed in claim 1, wherein the input pulse has an average power greater than 300 W.

4. A frequency-shift system comprising a stretcher, an amplifier and a compressor as claimed in claim 1.
